(19) United States
(12) Patent Application Publication
(10) Pub. No.: US 2024/0335805 A1
(43) Pub. Date: Oct. 10, 2024

(54) CONTAINER FOR ACCOMMODATING A FLUID

(71) Applicant: THALETEC GmbH, Thale (DE)

(72) Inventor: Jurgen Reinemuth, Blankenburg (DE)

(73) Assignee: THALETEC GmbH, Thale (DE)

(21) Appl. No.: 18/709,970

(22) PCT Filed: Dec. 14, 2022
(86) PCT No.: PCT/EP2022/085883

§ 371 Date: May 14, 2024

(30) Foreign Application Priority Data
Dec. 23, 2021 (DE) 10 2021 134 483.2

(51) Int. Cl. B01F 35/00; B01F 35/92; B01F 101/00

(52) U.S. Cl. CPC B01F 35/55; B01F 35/92; B01F 2101/2204

(57) ABSTRACT

The invention relates to a container (10) for accommodating a fluid, in particular a mixing container, comprising: a wall (12, 14, 16) which defines a space (22) for accommodating the fluid and has an enamel coating on a surface facing the fluid, and an insert element (46, 66) which is arranged in the accommodating space, the insert element having an enamel coating on an outer surface facing the fluid, and the insert element being fastened to a floor portion (16) of the wall by means of an integrally bonded connection (48).

The invention relates to a container for accommodating a fluid, in particular a mixing container, comprising a wall, which defines a space for accommodating the fluid and has an enamel coating on a surface facing the fluid, and an insert element, which is arranged in the accommodating space, the insert element having an enamel coating on an outer surface facing the fluid.

In appliance construction, there exists a need for containers for fluids. These fluids are, in particular, liquids in which and with which chemical and pharmaceutical operations and reactions take place. Therefore, such containers are also referred to as reactors. Prior to and during the chemical and pharmaceutical operations, these liquids can be exposed to high temperatures and/or high pressures. Very aggressive fluids may also be involved.

It has therefore proven useful to have an enamel coating on the inner side of these containers, that is, on a surface that is in contact with the fluid or media. An enameled inner wall of containers of this kind can meet all chemical and thermal requirements to the greatest extent.

Especially desirable is to design the enamel coating of the inner wall of these containers as such to be as uninterrupted as possible and to have no breaks, because such breaks constitute a weak point and, in each instance, it must be ensured that the transitions and egresses of the enamel coating present there are then appropriately protected.

At the same time, however, there exists a need to furnish various components with access to the accommodating space. Thus, first of all, it is necessary that the fluids can be filled into the container and withdrawn from it. Moreover, during the reactions that take place, it is widely desired that additional constituents or further fluids are added or else samples are taken.

Furthermore, in containers of the kind mentioned above, stirring devices are also typically provided in order to mix together and set in motion the fluids that are present. Moreover, it is desired to provide measuring instruments in the containers to record the temperature or other data as characteristic process parameters, for example, and to be able to transmit them externally during the ongoing reactions.

Finally, it is often desirable to arrange so-called baffles within the containers in order to further influence the motion of the fluid produced by the stirring devices and, in particular, in order to disrupt a pure rotation of the total quantity of fluid caused by the stirrer in such a way that a true thorough intermixing of the fluids and a blending of the constituents and reaction products with one another is brought about.

Baffles of this kind are often designed as flat metal plates, which are situated in the interior of the container and have a shape that is intended to facilitate their insertion and, at the same time, to ensure that the intermixing of the fluid in the container is as effective as possible.

A conventional way of arranging and fastening insert elements, such as, for instance, measuring probes, fluid feed lines or fluid discharge lines, or baffles, in the interior of the container is to pass the insert element through a passage of the above-described kind, for example, and to have it protrude into the interior space. The fastening then typically occurs at the passage on the outside by means of a flange connection. Such a solution is described in DE 20 2008 009 252 Ul, for example. The fastening by means of a passage and a flange connection has the drawback that the enamel coating cannot be designed to be continuous in the region of the passage or the flange connection. Instead, there remains a gap, which needs to be separately sealed. This can have a detrimental effect on the corrosion protection. In the mentioned published patent specification, this problem is countered in that, among other things, the passage and the flange connection are arranged on a cover portion of the container and thus, fundamentally, the gap there does not come in direct contact with the liquid in the container. Nevertheless, gases can reach the gap. Moreover, in this way, construction space at the cover, which is typically sparing, is taken up and, on the cover portion, it is desirable to arrange or fasten yet further insert elements.

U.S. Pat. No. 7,607,821 B2 describes, in each of various embodiments, a container of the above-mentioned kind, in which a baffle is fastened to a side wall of the container through a welded connection. The baffle comprises a cavity through which a cooling fluid is able to flow. To this end, a passage connection is provided between an interior space of the baffle and a region outside of the side wall. Accordingly, no space is occupied on the cover by the baffle and the welded connection permits a continuous enamel coating. However, the embodiments described in this published patent specification have, among other things, the drawback that, in regard to the strength of the connection, the baffle is suboptimally arranged, because the baffle, in conjunction with the load of the flow due to the stirred liquid, gives rise to a relatively large lever effect. As a result, the relatively short connection site between the baffle and the side wall provided in accordance with this published patent specification is subject to a strong load. Accordingly, the connection needs to be designed with an especially large material thickness or else only a relatively small design of the baffle is possible. For larger containers, it would then be necessary to provide a plurality of baffles, thereby increasing the costs for such a container.

An object of the invention is to create an improved possibility for arranging and fastening an insert element in a container of the above-mentioned kind, said insert element having good corrosion protection with an advantageous stability and a simple construction.

This object is achieved by a container according to claim 1 and, in particular, in that the insert element is fastened to a floor portion of the wall by means of an integrally bonded connection.

Numerous and substantial advantages ensue from this simple solution in itself.

By way of the arrangement of the connection on a floor portion, it lies in a region of the accommodating space of the container in which, typically, a strong flow is to be expected insofar as the liquid is stirred. Typically, a stirring device is also arranged in the proximity of the floor portion, thereby contributing to the fact that, typically, the flow in the proximity of the floor portion is especially strong. Accordingly, essentially a shear load acts on the connection, whereby, however, such a shear load can be relatively well tolerated by the connection.

The insert element extends preferably over a certain length starting from the connection and going upwards into the accommodating space. As a result, the force of the flow gives rise to a lever, which results in a bending load on the connection. However, the bending load is relatively small, because the flow tends to be less strong further above in the accommodating space, so that the lever does not exert such a strong effect. In addition, the floor-side fastening, in comparison to a fastening at the side wall, makes possible-once again on account of the lever effects-a positioning of the insert element at a larger distance from the side wall and thus relatively far in the center. However, because the flow rate also decreases with decreasing radius with respect to the center axis, an additional reduction of the effective load on the connection ensues.

Furthermore, a torsional load on the connection is especially low, because, on the one hand, only relatively low torsional forces are exerted by the flow on the insert element and, on the other hand, only small lever effects are to be expected in regard to the connection.

Although the loads on the connection are also fundamentally dependent on the specific shape of the insert element, the advantageous design in accordance with the invention and the arrangement of the connection make possible nevertheless a quite free and advantageous design of the insert element and, at least in terms of tendency, leads to the advantages in the load scenario.

Fundamentally, the advantages mentioned in regard to the load, in particular, are based on, among other things the circumstance that the connection-in regard to the height thereof-is arranged essentially precisely at the point where the highest flow load is to be expected. Conversely, this leads to the conclusion that other parts of the insert element are arranged in regions that tend to have a lower flow, as a result of which the lever effect thereof on the connection is relativized. As a result, the design of the insert element is relatively free, even without an especially massive connection. For example, the insert element can be designed with a relatively large length, without endangering the connection.

An upper end of the insert element can preferably be arranged above a stirring blade of a stirring device of the container. Alternatively or additionally, an upper end of the insert element can be arranged, for example, above a vertical container center.

Furthermore, an integrally bonded connection can fundamentally be designed to be markedly lighter in such a way that, in terms of fluid dynamics, its flow resistance or the force on the connection resulting from the flow is relatively low. It is thereby possible in a simple way, for instance, to give the connection a rounded or beveled shape. This reduces, in particular, the above-mentioned shear load on the connection. And, in turn, it holds that the advantage of the good design in terms of fluid dynamics comes to effect especially in the region of the strongest flow, typically in the proximity of the floor portion.

The connection or a region of the connection can also be designed between the floor portion and the insert element in such a way that the moment of bending resistance thereof tangentially to the flow direction is higher than the moment of bending resistance perpendicular to the flow direction (radial direction); that is, the connection or the region of the connection can be designed in a “load-appropriate” manner.

In summary, the arrangement of the connection at the floor, on the one hand, and the design of the connection as an integrally bonded connection, on the other hand, result in a synergistic effect, which affords an especially low and favorable load for the connection. Accordingly, given a low use of material, it is possible to achieve a high stability and the insert element can be designed relatively freely, in particular relatively long upwards. For high containers, it is not necessary to provide, for instance, a plurality of insert elements one above the other and, correspondingly, additional connection sites. Furthermore, the insert elements can be arranged, in particular, as baffles relatively far in the center and can be designed to be relatively large, as a result of which a strong baffling effect ensues on account of the favorable load situation, but without endangering the connection.

In terms of the length of the insert element, it is to be noted that, for the load, above all the length of the insert element that is situated below the liquid surface during operation is relevant, Because the insert element is fastened below, it can be, for example, simply as long as necessary; that is, for instance, it can extend to the liquid surface. This proves advantageous, in particular in comparison to an insert element that is fastened to a cover portion of the container by means of a passage and a flange connection, for example. Here, the insert element, insofar as it has to protrude into the liquid, already has a length above the liquid surface that, in regard to the mechanical lever effect, is additionally effective. By way of the invention, such a lever that is unnecessary for the process is eliminated more or less.

It is noted that the advantages in regard to the load do not exist just for an essentially static load, but rather that these advantages also extend essentially to a dynamic load. In particular, owing to the mechanically favorable design and arrangement, the connection is especially less sensitive to any vibrational excitation.

Fundamentally, the integrally bonded connection makes it possible to avoid a gap between the connection partners as well as a sealing with foreign material. In this way, there ensues a high corrosion resistance and an easy cleaning. Advantageously, the integrally bonded connection can likewise be coated with enamel on its surface; that is, in particular, a continuous enamel coating can be provided between the insert element and the wall.

Furthermore, it is especially advantageous when all media-contacting surfaces in the interior of the container are coated with enamel.

Moreover, in contrast to a passage with a flange connection, the integrally bonded connection makes it possible, for example, for essentially no dead space to be present in the region of the connection. Instead, a flow and, in particular, an intermixing of the fluid in the container is ensured essentially everywhere.

Furthermore, the fact that the insert element is fastened to a floor portion makes it possible for more construction space to remain for other inserted parts, such as, for instance, feed lines or measuring probes, at the cover portion.

Last but not least, the container according to the invention can also be produced in an especially simple manner.

The insert element can have, for example, a temperature control device, such as, for instance, a fluid line for a temperature control fluid. In this way, for instance, the fluid in the accommodating space of the container can undergo temperature control. It is fundamentally also conventional that, at its wall, the container has a temperature control system for the fluid in the container—referred to below as a container temperature control system. Here, it is possible, for instance, for a double-wall system or a coiled pipe or half-coiled pipe to be employed, through which a temperature control fluid flows. The temperature control device in the insert element can be provided alternatively or additionally to a container temperature control system.

The arrangement and design of the connection according to the invention also proves, as such, especially advantageous for an insert element with a temperature control device. This is because the provision of a passage for temperature control fluid is fundamentally offered at the connection between the insert element and the wall. Because, in accordance with the invention, the connection is arranged at a floor portion, the passage is likewise arranged at a floor portion. In this way, it ensues more or less inherently that the temperature control device of the insert element runs empty by itself when no more pressure is applied and the associated valves are open.

A further special advantage is that, on account of the bottom arrangement of the connection, the temperature control device of the insert element can be connected in an especially simple way to a container temperature control system that is designed as a double-wall system. A double-wall system makes possible a relatively simple and low-cost construction for very effective temperature control of the container, in particular in comparison to a coiled pipe placed around the container.

In general, containers of the kind under discussion here have a cover portion, which is also referred to as an upper floor, a cylindrical portion, which is also referred to as a shell, and a floor portion or lower floor. In this case, the wall of the container mentioned herein is formed by the portions.

The portions of the container are typically welded to one another. After the portions have been joined together, the inner walls thereof, which define the accommodating space of the container, are coated with enamel. The insert elements according to the invention, which are fastened to a floor portion by means of an integrally bonded connection, can advantageously likewise be coated with enamel during this operation—in particular, inclusive of the surfaces of the integrally bonded connection between the insert element and the wall.

Advantageously, a stirring device can be arranged in the accommodating space of the container. This stirring device can have, for example, a stirring shaft and a plurality of stirring blades. The stirring shaft can be passed, for example, through a cover portion of the wall of the container. The stirring device can act, for example, in proximity to the floor and, for example, can be situated exclusively there.

The insert element can constitute a baffle, for example. Fundamentally, it ensues from the construction in accordance with the invention that the insert element is situated necessarily in the liquid present in the container. Insofar as the liquid is stirred, there ensues from this a certain baffling effect. A special advantage of the solution in accordance with the invention lies in the fact that the baffling effect is also effective in the case of an especially low level of fluid. Constructions in which the insert element is fastened to a shell or a cover portion typically entail the problem that the insert element cannot extend directly to the floor portion. Instead, for various reasons, a certain distance between the wall at a floor portion and the bottom tip of the insert element is generally necessary. This distance is necessary in many constructions, for instance, in order to coat both the tip of the insert element as well as the underlying wall with enamel. Insofar as an insert element is fastened to a cover portion via a passage and a flange-such an insert element can be coated with enamel separately, for examplea certain safety distance from the sensitive enamel coating of the floor portion is necessary at the bottom end. In addition, on account of the above-described lever effect, such an insert element also cannot be passed very far downwards into the container. Accordingly, without any special measures and in contrast to constructions of prior art, the invention makes possible a baffling effect even for an especially low level of fluid in the container without any need to take special measures.

For example, the insert element can be designed to be oblong and/or to have a longitudinal axis that is aligned at least essentially vertically.

The insert element can extend starting from the integrally bonded connection, for example, at least essentially vertically upwards, leading to an especially advantageous arrangement in regard to the force transmission of a flow in the container.

Preferably, the insert element can extend, starting from a region of the floor portion, the surface of which is directed upwards, at least essentially vertically upwards. Thus, the integrally bonded connection then lies in this very region. On principle, the region of the floor portion with an upwards directed surface lies close to a typically present stirring device. Therefore, the connection lies in the region that is especially influenced by the flow. This acts advantageously in regard to the lever effect, since the strongest flow has the smallest lever effect owing to the advantageous arrangement.

Furthermore, it is advantageous when the connection, in particular in the horizontal direction, is spaced apart from a cylindrical portion of the wall, preferably at a distance of at least 1%, especially preferably at least 2%, of an inner diameter of the container and/or of the cylindrical portion.

It can also be provided that a main axis or longitudinal axis of the insert element is aligned essentially parallel to a main axis of the container.

It can be provided in an advantageous way that the insert element is fastened to the wall by means of solely one connection and/or that the connection has solely one connection region. For example, the insert element can be fastened exclusively to a floor portion and/or the integrally bonded connection can be the sole connection of the insert element to the wall.

Advantageously, the connection can be arranged below a stirring device.

The connection can be designed, for example, to be at least essentially tubular in shape and/or to have and/or to constitute an at least essentially tubular transition between the insert element and the floor portion.

In accordance with an embodiment, it is provided that the connection is designed as a welded connection. Such a connection offers a high stability and is easy to produce. The welded connection can have, for example, a circumferential weld seam and/or an annular weld seam.

The surface, for example, of the integrally bonded connection can be treated after production of the connection by grinding and/or sand blasting, for example. Subsequently, it is possible, for example, for an inspection of the integrally bonded connection to be carried out. The surface of the integrally bonded connection can be coated with enamel, for example.

Furthermore, it can be provided that the insert element has a first portion, in particular a connection portion, and, in this portion, the insert element is formed at least essentially tubular in shape, circularly cylindrical in shape. and/or with a circular cross section. Alternatively or additionally, it can be provided that the insert element has a second portion, with the insert element in the second portion having an at least essentially circular, elliptical, oblate, or polygonal, in particular triangular or square, cross section.

Insofar as reference is made here to a “second” portion, this serves solely for facilitating the differentiation and reference, but does not mean that, necessarily, a first portion, as specified above, is present. Fundamentally, however, it is preferable that the insert element has a first portion and a second portion, with a different cross section being provided in the first portion than in the second portion. For example, the cross section can refer to an outer surface and or to an inner surface of the insert element. The portion or portions can fundamentally be designed to be cylindrical, for example.

Fundamentally, as necessary, it can be advantageous for the insert element to be formed differently in different portions. Thus, for example, it is possible to provide a connection portion that is optimized in terms of its shape for the production and/or stability of the connection. Furthermore, it is possible to provide, for example, a baffle portion, which, in terms of its shape, is optimized for the baffling effect.

In accordance with a further development, it is provided that, at least in a region of the integrally bonded connection, the insert element has an at least essentially cylindrical, preferably circularly, cylindrical portion, with the cylindrical portion extending, preferably with an at least essentially constant cross section, further downwards starting from the integrally bonded connection. In another embodiment, the insert element has a cavity, with the container having a container temperature control system and with the cavity being designed in such a way towards the outside that it passes in the container temperature control system. These embodiments allow an especially simple production of an insert element that is always accessible from the outside, namely, from below, in terms of its interior space.

In a further advantageous embodiment, the integrally bonded connection has a rounded transition between the insert element and the wall. As explained above, this has advantages in terms of fluid dynamics and makes possible a simple enamel coating of the connection, that is, a good corrosion protection. The connection can have, for example, a flanged collar. Such a flanged collar is relatively easy to produce and makes possible a high strength of the connection.

The insert element can have, for example, a temperature control device. For example, the insert element can have a first fluid passage and a second fluid passage as well as, between the fluid passages, a fluid line for a temperature control fluid, whereby, in particular, it is possible by way of the fluid line for temperature control fluid to flow through the insert element. This makes possible an advantageous temperature control effect for the fluid present in the container.

In an advantageous way, the first fluid passage can be connected, in particular directly, to a container temperature control system, in particular a double-wall cavity or a coiled pipe or half-coiled pipe, or to an external connection port or else constitute such an external connection port. In an advantageous way, the second fluid passage can be connected, in particular directly, to a container temperature control system, in particular to a double-wall cavity or to a coiled pipe or half-coiled pipe. Fundamentally, the second fluid passage can also be connected to an external connection port or else constitute an external connection port. The connection to the container temperature control system makes possible a simple construction and a simple operation. The connection to the external connection port makes possible an especially need-appropriate control of the temperature control device of the insert element.

The first fluid passage can preferably be formed as an inlet for the fluid line of the insert element. The second fluid passage can preferably be formed as an outlet for the fluid line of the insert element.

Preferably, the fluid line of the insert element can be formed to be self-draining and/or completely drainable. This makes possible a simple maintenance and handling of the container. “Self-draining” is to be understood as meaning that the fluid line is aligned and formed in the insert element in such a way that the fluid drains by itself owing to the force of gravity, for instance, when no pressure is applied and the passages are not blocked by valves or the like. In particular, the temperature control device of the insert element is set up so that the draining occurs into the container temperature control system.

In accordance with an advantageous example, the fluid line of the insert element and a container temperature control system can have a common outlet. This outlet can be arranged, for example, at a floor portion of the container and/or below the integrally bonded connection. In an advantageous way, the container temperature control system can also be formed to be self-draining.

In a further development, the fluid line of the insert element defines a fluid forward path and a fluid return path. The fluid forward path and/or the fluid return path can extend preferably over at least essentially the entire length of the insert element. Preferably, the first fluid passage and the second fluid passage are both situated at the bottom end of the insert element. These features serve for an especially simple construction of the temperature-controlled insert element.

In accordance with an embodiment, the fluid line of the insert element is defined in a first line portion, in particular in a fluid forward path and preferably completely, by an intermediate wall, in particular a pipe. In accordance with a further embodiment, the fluid line is defined in a second line portion, in particular in a fluid return path, partially by the outer wall of the insert element and/or partially by an intermediate wall, in particular a pipe. The construction with an intermediate wall, in particular a pipe, makes possible an especially simple construction with effective temperature control.

Furthermore, it can be provided advantageously that the first line portion passes through an outer wall of a double wall of a container temperature control system and/or that the intermediate wall extends through an outer wall of a double wall of a container temperature control system. This makes possible a simple construction, for example, for a connection to an external connection port, such as, for instance, to a temperature control fluid feed. The intermediate wall can be welded, for example, to the outer wall of the double wall.

In an embodiment, the intermediate wall is designed as a pipe. Especially advantageously, the pipe can be arranged spaced apart and/or arranged concentrically, at least in sections, preferably at least essentially over its entire length within the insert element and/or at least essentially over its entire circumference from and/or to the outer wall. Accordingly, it is possible to achieve a large heat exchange effect for an especially simple construction.

In accordance with a further development, the insert element comprises a fluid line, which forms a fluidic connection between the accommodating space and an outer connection port. This further development makes possible, in particular, the discharge of a liquid from a height in the container at which a fluid passage of the fluid line is provided on the side of the accommodating space. It is hereby possible in an especially simple way to create a device for phase separation. The phase that is arranged for the fluid passage can flow off easily through the fluid line an account of the floor-side fastening of the insert element. Accordingly, not even a pump is required for the discharge of a phase.

It is also possible, for example, to provide a plurality of insert elements formed as a device for phase separation, with the first fluid passage being at a different height in each instance. In this way, it is possible to separate more than two phases from one another.

In accordance with a further embodiment, a measuring device is fastened to and/or arranged on a floor portion, preferably a temperature measurement probe for recording, in particular, the temperature of the medium in the interior of the container.

The invention will be explained below, solely by way of example, on the basis of schematic drawings.

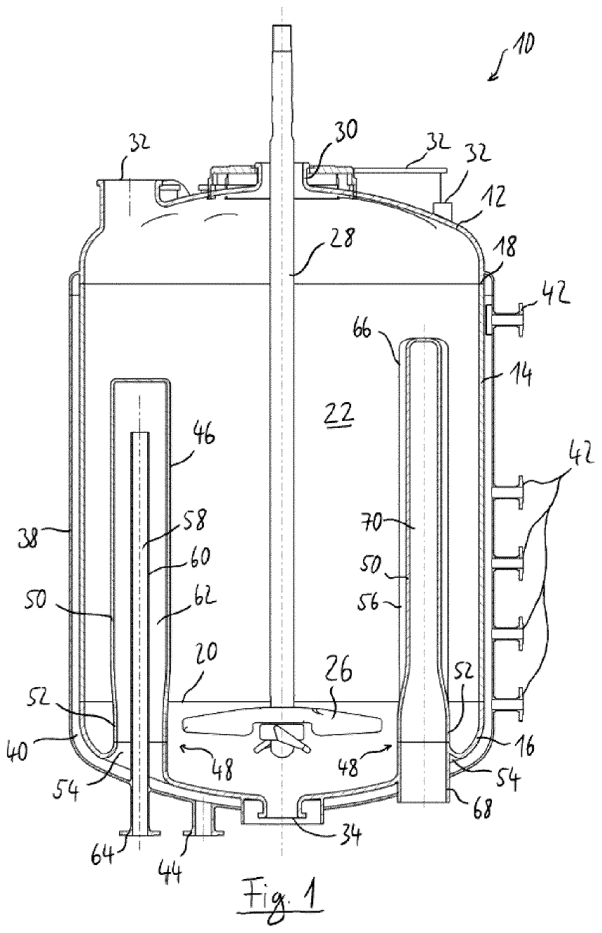

FIG. 1 shows in a sectional illustration an embodiment of an enameled container for use in chemical processes, for example.

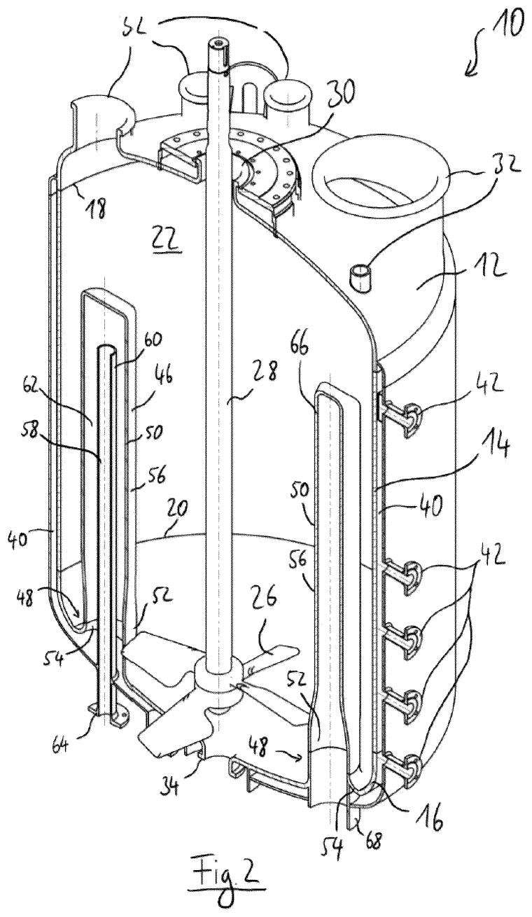

FIG. 2 shows the container of FIG. 1 in a perspective cut illustration.

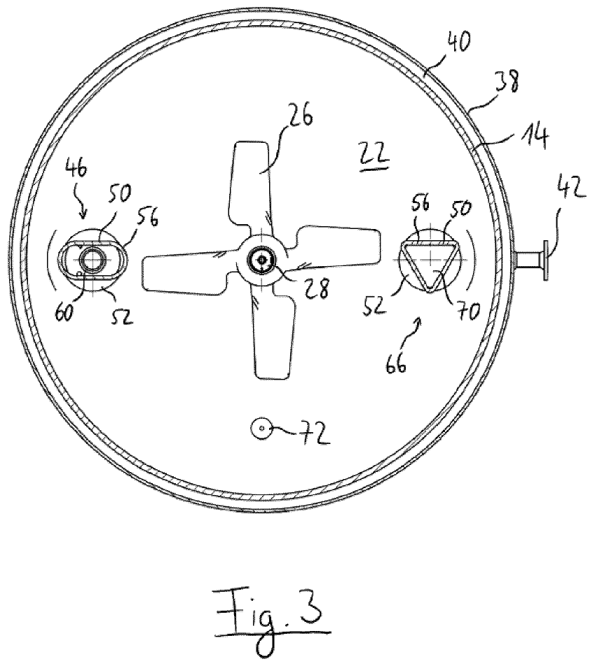

FIG. 3 shows a further sectional illustration of the container of FIG. 1 and FIG. 2.

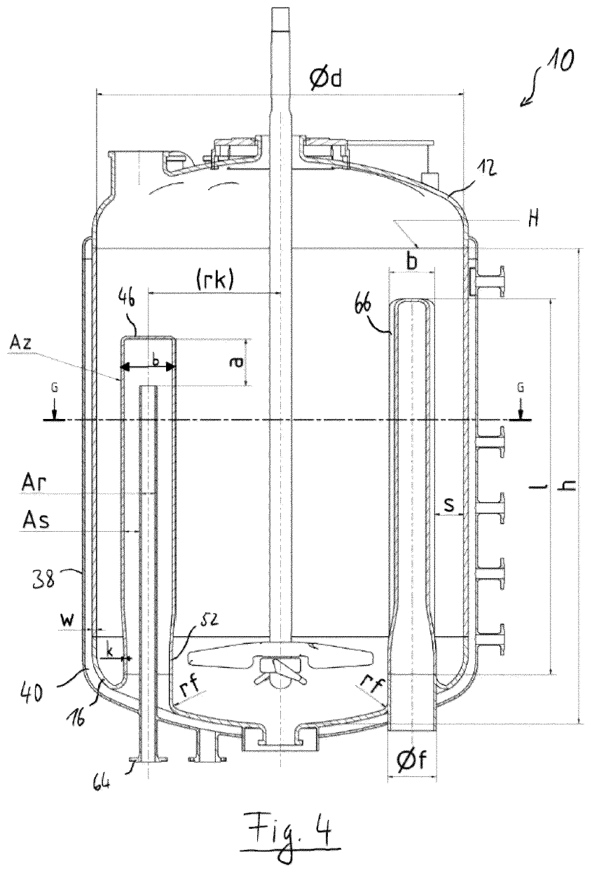

FIG. 4 corresponds to FIG. 1, but highlights above all the dimensional specifications.

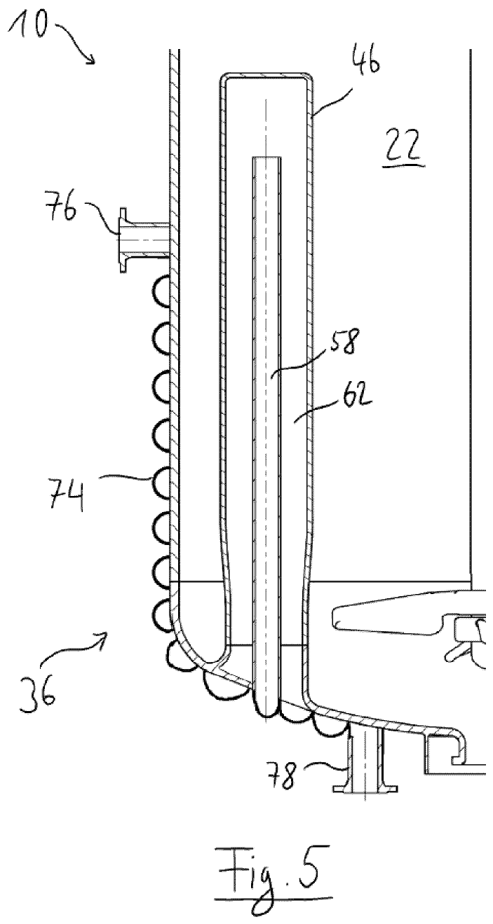

FIG. 5 illustrates a further embodiment of an enameled container.

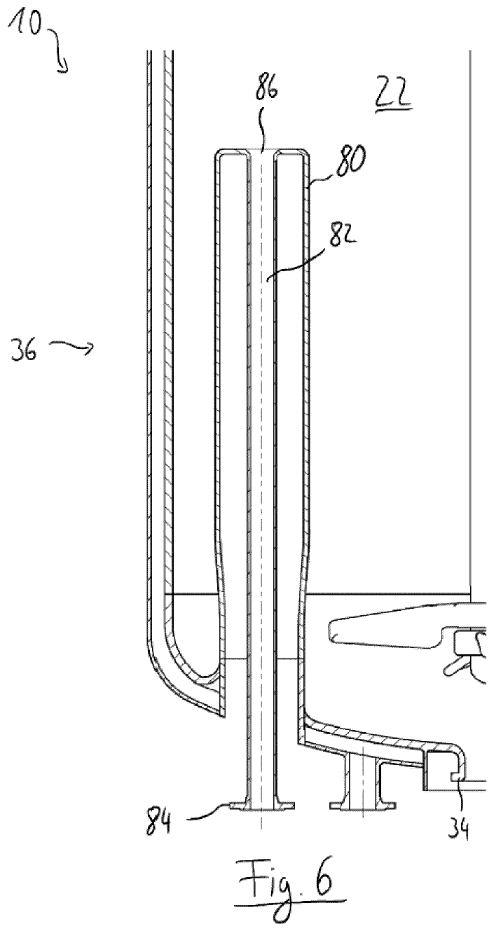

FIG. 6 illustrates a further embodiment of an enameled container.

FIG. 1 and FIG. 2 show a container 10 in a longitudinal cut. On account of the similar illustration, FIG. 1 and FIG. 2 are referred to together unless stated otherwise.

The container 10 comprises a cover portion 12, a cylindrical portion 14, and a floor portion 16. The portions 12, 14, 16 can be formed separately from one another, for example, and subsequently joined together in an integrally bonded manner at the junction points 18, 20 and, in particular, they can be welded there.

The portions 12, 14, 16 also form a wall of the container 10, which defines an accommodating space 22 in the interior of the container 10. The accommodating space 22 serves for receiving a fluid, such as, for example, for carrying out a chemical process within the container 10.

The wall or the portions 12, 14, 16 are coated with enamel from the inside in order to form a corrosion protection against, among other things, chemically aggressive fluids in the accommodating space 22.

Arranged in the accommodating space 22 is a stirring device 24. Said stirring device acts in the region of the floor portion 16 with stirring blades 26 that are set at an angle and are driven by means of a stirring shaft 28. The stirring shaft 28 extends from outside into the accommodating space 22 and hereby passes through a passage 30 provided in the cover portion 12.

Provided at the cover portion 12 are further passages 32, via which the various functional devices can be introduced as insert elements into the accommodating space 22. An insert element of this kind can be fastened at the passage 32 in question by way of a flange connection. In the figures, no functional devices or insert elements are depicted, but rather the passages 32 are depicted as being open. The passages 32 are typically closed during operation of the container 10, this occurring either with an insert element or with a cover. Functional devices that can be introduced via the passages 32 can be, for instance, feed lines, discharge lines, and/or measuring devices. Other devices for influencing the chemical processes are also possible-fundamentally also baffles.

At the floor portion 16 or, more specifically, at the lowest point of the container 10, said container has an outlet 34. In this way, the container 10 is designed to be self-draining, so that a liquid present in it flows off automatically on account of the force of gravity at least essentially completely after the outlet 34 is opened.

The container 10 has a container temperature control system 36, which is designed as a double-wall system. The container temperature control system 36 comprises an outer wall 38 as well as an inner wall, which is formed essentially by the wall of the cylindrical portion 14 as well as the wall of the floor portion 16. Defined between the outer wall 38 and the inner wall 14, 16 is a cavity 40, through which a temperature control fluid can be passed for the purpose of temperature control of a liquid present in the accommodating space 22. For this purpose, side ports 42 are additionally provided and serve as inlets for the temperature control fluid in the cavity 40. The container temperature control system 36 comprises, in addition, a connection port 44, which serves as an outlet for the temperature control fluid. A temperature control can comprise, for example, a cooling and/or a heating.

Arranged in the accommodating space 22 is an insert element 46, which is designed as a baffle and which also has an enamel coating at an outer surface facing the liquid that is present in the accommodating space. The insert element 46 is fastened to a floor portion 16 by means of an integrally bonded connection 48.

The integrally bonded connection 48 is designed as a welded connection. An outer wall 50 of the insert element 46 is designed to be circularly cylindrical in a connection portion 52. Provided at the floor portion 16 is a flanged collar 54, which extends upwards from the floor portion 16 and likewise forms a circularly shaped connection site. The circular shapes of the outer wall 50 and the flanged collar 52 in the connection region correspond to each other and are welded at their junction point.

The connection 48 can be ground and/or sand-blasted, for example, after the welding. After an inspection of the welded connection, the connection 48 can be coated with enamel, for example, in the same operation as that of the inner wall 12, 14, 16 of the container 10 as well as the outer wall 50 of the insert element 46.

The insert element 46 forms a baffle. The outer wall 50 is differently formed in a baffling section 56 than in the connection portion 52, namely, although likewise cylindrical in shape, laterally oblate. This can be seen, for instance, in FIG. 2 and FIG. 3.

The insert element 46 comprises a temperature control system, which comprises a fluid line for a temperature control fluid. The fluid line comprises a first line portion 58, which, in this embodiment, is defined over its full circumference by an intermediate wall, namely, a pipe 60. A second portion 62 is defined by the pipe 60 in the interior and the outer wall 50 in the exterior. The pipe 60 passes to the outside through the outer wall 38 of the double wall and is welded to it for the purpose of a tighter fastening.

A connection port 64 serves preferably as an inlet for the temperature control fluid. Accordingly, the line portion 58 forms a fluid forward path and the line portion 62 forms a fluid return path.

The second line portion 62 opens into the cavity 40 of the container temperature control system 36. Accordingly, the connection port 44 forms a common outlet for the container temperature control system 36 as well as for the temperature control system of the insert element 46.

A further insert element 66, such as, for instance, one designed differently and likewise as a baffle, can also be seen in FIG. 1 to FIG. 4. The insert element 66 is arranged in the accommodating space 22, coated with enamel on its outer surface, and fastened to a floor portion 16 of the wall by means of an integrally bonded connection 48.

The integrally bonded connection 48 of the insert element 66 likewise has a flanged collar 54 and is designed as a welded connection between two circularly shaped cross sections. In contrast to the insert element 46, it is to be emphasized here that, starting from the connection 48, a circularly cylindrical portion 68 passes downwards through the container temperature control system 36 or through the double wall 16/38. In this way, it ensues that a cavity 70 of the insert element 66 is open downwards. The insert element 66 and its cavity 70 can be provided, for example, with a temperature control system or else can remain free.

Similarly to the case for the insert element 46, the insert element 66 is designed in a connection portion 52 with its outer wall 50 in a circularly cylindrical manner. In a baffling section 56, the outer wall 50 of the insert element 66 is designed, by contrast, essentially in a triangular shape, as can be seen especially well in FIG. 3.

Particularly based on FIG. 1 and FIG. 2, it can be seen that the connections 48 of the insert elements 46 and 66 to the floor portion 16 are arranged in a region in the accommodating space 22 in which a relatively strong flow is to be expected on account of the action of the stirring device 26. In this region, however, a mechanical lever is hardly effective on the connection 48, so that the flow in this region can be withstood easily by the connection 48. With increasing height in the accommodating space 22, the strength of the flow is less strong, because the distance to the stirring blades 26 decreases and also because the pressure of the liquid decreases. Accordingly, at increasing height, a lever effect that exists on account of the oblong shape of the insert elements 46 and 66 is relativized by lower forces acting on the insert elements 46 and 66. The load situation is therefore especially favorable.

In FIG. 3, furthermore, a temperature measuring device 72 can be seen, which is likewise arranged at a floor portion 16.

Based on FIG. 4, the construction of the embodiment of FIG. 1 to FIG. 3 is explained yet further in regard to advantageous size relationships. FIG. 4 corresponds to FIG. 1, but, for reasons of clarity, omits a large part of the reference signs and instead shows certain relevant size designations. Insofar as herein size relationships are specified as advantageous, it is understood that they are not limited to the construction in accordance with FIG. 4, but rather are valid in general.

At the floor portion 16 of the enameled container 10 during the production thereof, at least one off-center opening with a diameter f is introduced. In the direction of the interior of the container, this opening is rounded with a radius of rf, in that, in particular, a flanged collar is produced. On the flanged collar 54 that is thus formed and is aligned in the direction of the interior of the container, an insert element 46, 66, in particular a baffle, is attached in an integrally bonded manner and, in particular, is welded in place. Accordingly, a one-piece component is formed. The insert element 46, 66 is a hollow body with a cross section and a length 1. The cross section is governed by the requirements of the stirring process and, for example, can be triangular, oval, or else circular.

The length 1 of the insert element 46, 66 is likewise designed according to the requirements of the stirring process. From the point of view of stability, the insert element 46, 66 should be as short as possible. A proven length l results, in particular, from the height h of the surface of the liquid for a nominal filling height H in the non-stirred container. The length of the insert element can lie, in general, preferably between 0.7 h and 1.2 h. 1=0.8 h has proven to be especially favorable.

After the steps of surface preparation by grinding of the weld seams and sand blasting of the inner surface and after inspection of the weld seams, the enamel coating process follows. The entire (inner) surface of the container 10 that is in contact with the media is hereby provided with an enamel coating.

Accordingly, in a simple way, it is possible to produce an enameled container for the stirring of essentially fluid media, whereby the enameled container has at least one integrated baffle, which is fastened to the floor of the container in an non-detachable manner.

The upper floor or cover portion 12 of the container 10 remains free of the insert elements 46, 66, so that all ports for carrying out the chemical process in the container (stirring process) are available.

Because the insert elements are connected to the floor portion 16 in an integrally bonded manner and since, in addition, the connection points are rounded generously with the radius rf, there ensues an inner surface that is easy to clean. Furthermore, the internal volume of the container 10 is completely self-draining.

The connection between the insert element 46, 66 and the container floor 16 is integrally bonded and seal-free. Accordingly, there is no risk of undesired leakages and lack of tightness.

The insert elements extend to the container floor, so that the baffling effect thereby brought about is ensured even in the case of the smallest levels of filling.

In comparison to conventional baffles, which are installed in one container port or in a plurality of container ports on the cover portion of the container and protrude into the liquid, the insert elements 46, 66 can be designed to be shorter in length and larger in diameter and thus mechanically appreciably more stable and less sensitive toward vibrational excitation.

In a suitable way, the insert element 46 can be furnished with a pipe 60 in the interior such that the heating medium or cooling medium (also referred to as temperature control fluid or service medium) can flow through in the jacket space. Accordingly, the surface of the insert element 46 contributes to the maximization of the heat exchange in the container 10.

The construction further makes possible an advantageously easy production in high quality.

FIG. 4 shows, additionally to the line of cut G, the plane of cut of FIG. 3.

Therefore, FIG. 4 shows an advantageous mixing container 10, comprising an upper floor (or the cover portion), a shell (or a smallest cylindrical portion), and a bottom floor (or floor portion) as well as a jacketing (or a double-wall¹ container temperature control system) in the cylindrical region and in the floor region, with at least one insert element 46 on the bottom floor of the container 10 being connected to it in an integrally bonded manner and extending into the interior volume of the container 10. ¹ [Translator's Note] “Doppelboden” (double-floor) instead of “Doppelwand” (double-wall) in the German original.

The insert element 46 is designed to be hollow on the inside and is connected to the interior volume of the cavity 40 formed by the outer wall 38 of the container 10 and the inner wall of the jacketing.

In its interior volume, the insert element 46 has a pipe 60, which ends at a distance a from the upper end of the insert element. The distance a lies preferably between 0.5 and 1.5 times the width b of the insert element, especially preferably at 1 b. The fluid flow preferably passes through the pipe 60 from the connection port 64 arranged below in the direction towards the upper end of the pipe 60.

On the return path, the temperature control fluid flows through the cavity of the insert element 46 that surrounds the pipe 60 from top to bottom. Accordingly, an additional heat exchange surface Az results.

A cross-sectional surface As that is formed in the insert element 46 by the inner surface of the insert element 46 and the outer surface of the pipe 60 can preferably be designed in a way that is much smaller than a cross-sectional surface Ar that is formed by the inner cross section of the pipe 60. Preferably, As lies between 0.1 Ar and 0.5 Ar and, especially preferably, As=0.25 Ar. A connection region between the insert element 66 and the floor portion 16 can be designed, for example, to be essentially cylindrical with a diameter f and to have a radius rf between the floor portion 16 and the insert element 46.

For the insert element 66, it is provided that an interior space of the insert element 66 does not have any fluidic connection with the cavity 40 formed by the container wall and the jacketing.

Advantageously, it can be provided that the ratio of the width b of the insert element to an inner diameter d of the container lies between 0.05 d to 0.15 d and, especially preferably, is b=0.12 d. It is likewise advantageous when the ratio of a wall distance s to an inner diameter d of the container lies between 0.05 d and 0.15 d and, especially preferably, s=0.1 d.

The ratio of a wall thickness k of the insert element 46 in a connection portion 52 to a wall thickness wall in the floor portion 16 can be preferably between 0.5 w and 1.0 w and, especially preferably, k=0.7 w.

Illustrated in FIG. 5 is a further embodiment of a container 10, in which a container temperature control system 36 of the container 10 comprises a half-coiled pipe 74. There is provided a connection port 76, which forms an inlet for the half-coiled pipe 74. The insert element 46 or its line portions 58 and 62 are connected to the half-coiled pipe 74 in such a way that the temperature control fluid coming from the inlet initially passes through a plurality of windings in the half-coiled pipe 74, is subsequently carried into the line portion 58 in the insert element 46, then is carried back via the line portion 62 into the half-coiled pipe 74—this occurring in FIG. 5 to the right of the pipe 60—and, finally, after two windings in the half-coiled pipe 74, is drained off via the connection port 78.

In the embodiment in accordance with FIG. 6, the container 10 has, in turn, a container temperature control system 36 designed as a double wall, which is designed largely in accordance with FIG. 1. An insert element 80 is arranged in the accommodating space 22 and is fastened to a floor portion 16 by means of an integrally bonded connection 48. The insert element 80 comprises a fluid line 82, which forms a fluidic connection between the accommodating space 22 and an outer connection port 84. At its end facing the accommodating space 22, the fluid line 82 has a fluid passage 86. In this way, it is possible, in particular, to drain off a liquid phase that is present at the height of the fluid passage 86 and lies above a heavier liquid phase lying further below. The heavier liquid phase can be drained off, for example, via the outlet 34. In this way, it is possible, for example, to realize a phase separation. The interior of the fluid line 82 is preferably likewise coated with enamel. It can be provided, for example, with a plurality of insert elements 80 of this kind with different heights in order to also separate more than two phases from one another, for example.

### LIST OF REFERENCE NUMBERS

10 container
12 cover portion
14 cylindrical portion
16 floor portion
18 junction point
20 junction point
22 accommodating space
24 stirring device
26 stirring blade
28 stirring shaft
30 passage
32 passage
34 outlet
36 container temperature control system
38 outer wall
40 cavity
42 port
44 port
46 insert element
48 connection
50 outer wall
52 connection portion
54 flanged collar
56 baffling section
58 line portion
60 pipe
62 line portion
64 port
66 insert element
68 circularly cylindrical portion
70 cavity
72 temperature measurement probe
74 half-coiled pipe
76 port
78 port
80 insert element
82 fluid line
84 port
86 fluid passage

1. A container for accommodating a fluid, in particular a mixing container, comprising:
a wall, which defines an accommodating space for the fluid and has an enamel coating on a surface facing the fluid, and an insert element, which is arranged in the accommodating space, the insert element having an enamel coating on an outer surface facing the fluid,
characterized,
in that the insert element is fastened to a floor portion of the wall by means of an integrally bonded connection.

2. The container according to claim 1, wherein the insert element forms a baffle.

3. The container according to claim 1,
wherein the insert element, starting from the integrally bonded connection, extends at least essentially vertically upwards, in particular starting from a region of the floor portion, the surface of which is directed upwards, and/or
wherein the connection is spaced apart in the horizontal direction from a cylindrical portion of the wall.

4. The container according to claim 1,
wherein the connection is designed as a welded connection and/or
wherein the insert element has a first portion and, in the first portion, is formed at least essentially tubular in shape, circularly cylindrical in shape, and/or with a circularly shaped cross section and/or
wherein the insert element has a second portion,
wherein the insert element in the second portion has an at least essentially circularly shaped, elliptical, oblate, or polygonal, in particular triangular or square, cross section.

5. The container according to claim 1,
wherein the insert element has, at least in a region of the integrally bonded connection, an at least essentially cylindrical portion and wherein the cylindrical portion starting from the integrally bonded connection, extends further downwards.

6. The container according to claim 1,
wherein the integrally bonded connection has a rounded transition between the insert element and the wall and/or a flanged collar.

7. The container according to claim 1,
wherein the insert element has a first fluid passage and a second fluid passage as well as, between the fluid passages, a fluid line for a temperature control fluid.

8. The container according to claim 7,
wherein the first fluid passage is connected to a container temperature control system, in particular to a double-wall cavity or to a coiled pipe or half-coiled pipe, or to an external connection port or else constitutes such and/or
wherein the second fluid passage is connected to a container temperature control system, in particular to a double-wall cavity or to a coiled pipe or half-coiled pipe.

9. The container according to claim 7, wherein the fluid line of the insert element is formed to be self-draining.

10. The container according to claim 7, wherein the fluid line of the insert element and a container temperature control system have a common outlet.

11. The container according to claim 7, wherein the fluid line of the insert element defines a fluid forward path and/or a fluid return path, with the fluid forward path and/or the fluid return path extending over at least essentially the entire length of the insert element.

12. The container according to claim 7,
wherein the fluid line of the insert element is defined in a first line portion by an intermediate wall, in particular a pipe, and/or
wherein the fluid line in a second line portion is defined partially by the outer wall of the insert element and/or partially by an intermediate wall, in particular a pipe.

13. The container according to claim 12, wherein the first line portion is passed through an outer wall of a double wall of a container temperature control system and/or
wherein the intermediate wall extends through an outer wall of a double wall of a container temperature control system.

14. The container according to claim 12, wherein the intermediate wall is designed as a pipe, in particular wherein the pipe is spaced at least in sections at least essentially over its entire circumference from an outer wall of the insert element and/or is arranged concentrically with respect to the outer wall.

15. The container according to claim 1, wherein the insert element comprises a fluid line, which forms a fluid in connection between the accommodating space and an outer connection port.

16. A mixing container for accommodating a fluid, said mixing container comprising:
a wall which defines an accommodating space for the fluid and has an enameled coating on a surface facing the fluid; and
an insert element which is arranged in the accommodating space, the insert element having an enamel coating on an outer surface facing the fluid;
wherein the insert element is fastened to a floor portion of the wall by means of an integrally bonded connection.

17. The mixing container according to claim 16, wherein the insert element forms a baffle.

18. The mixing container according to claim 16, wherein the insert element, starting from the integrally bonded connection, extends at least essentially vertically upwards, in particular starting from a region of the floor portion, the surface of which is directed upwards, and/or wherein the connection is spaced apart in the horizontal direction from a cylindrical portion of the wall.

19. The mixing container according to claim 16, wherein the connection is designed as a welded connection and/or wherein the insert element has a first portion and, in the first portion, is formed at least essentially tubular in shape, circularly cylindrical in shape, and/or with a circularly shaped cross section and/or wherein the insert element has a second portion, wherein the insert element in the second portion has an at least essentially circularly shaped, elliptical, oblate, or polygonal, in particular triangular or square, cross section.

20. The mixing container according to claim 16, wherein the insert element has, at least in a region of the integrally bonded connection, an at least essentially cylindrical portion and wherein the cylindrical portion starting from the integrally bonded connection, extends further downwards.
